(19) United States
(12) Patent Application Publication
(10) Pub. No.: US 2007/0045197 A1
(43) Pub. Date: Mar. 1, 2007

(54) UV disinfection systems with tangential inlets and methods thereof

(75) Inventors: Ali Ogut, Pittsford, NY (US); Jian Yu, Beijing (CN)

Correspondence Address: NIXON PEABODY LLP - PATENT GROUP, CLINTON SQUARE, P.O. BOX 31051, ROCHESTER, NY, 14603-1051, US

(73) Assignee: Rochester Institute of Technology, Rochester, NY (US)

(21) Appl. No.: 11/480,058

(22) Filed: Jun. 30, 2006

Related U.S. Application Data
(60) Provisional application No. 60/696,758, filed on Jul. 6, 2005.

(51) Int. Cl. C02F 1/32

(52) U.S. Cl. 210/748; 250/436

(57) ABSTRACT

A disinfection system and method includes a reactor with a chamber and at least one radiation source. The chamber in the reactor has at least one inlet that is oriented to generate a vortex motion for a fluid introduced to the chamber. The radiation source is positioned to be offset from an axis which extends along a center of the chamber of the reactor. The radiation source at least partially directs radiation towards a circulating flow of the fluid in the chamber from the vortex motion in at least a gap between a wall of the chamber of the reactor and the at least one radiation source.

This application claims the benefit of U.S. Provisional Patent Application Ser. No. 60/696,758, filed Jul. 6, 2005, which is hereby incorporated by reference in its entirety.

### FIELD OF THE INVENTION

The present invention generally relates to disinfection systems and methods and, more particularly, to ultraviolet (UV) disinfection systems with tangential inlets and tangential and/or axial outlets and offset UV light sources and methods thereof.

### BACKGROUND

UV is light energy between about 100 nm and 400 nm wavelength, between the X-ray portion of the spectrum and the visible portion. In most UV disinfection applications, the short wave portion of the UV spectrum is used. This portion is referred to as UV-C and spans from about 200 nm to 280 nm.

UV is capable of destroying pathogens such as bacteria, viruses, and protozoa that can cause a variety of illnesses, such as amoebic dysentery, cholera, polio, and typhoid fever. UV radiation works by causing the formation of chemical bonds in cellular DNA. The exposure thus interrupts normal DNA replication and organisms are killed or rendered inactive. UV disinfection of water is currently used in drinking water, wastewater, and aquaculture industries. The development of UV technology for use in these industries has defined the operational parameters that influence the effectiveness of UV in water disinfection units.

UV-C technology is recognized by the EPA as one of four approved methods of sterilizing water, and is preferable over the other three approved methods, chlorine, iodine, and distillation, because of the cost of treatment and effectiveness of UV-C. More specifically, UV-C technology works almost instantaneously, leaving no residuals in the water. Additionally, UV-C technology is fast, does not alter pH, taste, and carries no risk of overdose. Further, UV-C technology is a non-chemical approach for microbial control and produces no toxic by-products. UV-C technology is now accepted by both the EPA and FDA as a safe, effective method of water disinfection. UV-C technology is also a “World Health Organization” approved method of disinfecting water.

The degree of microbial destruction is a function of both the time and intensity of the radiation to which a given microorganism is exposed. A short exposure time at high intensity is as effective as a long exposure time at low intensity provided the product of the exposure time and intensity, which is known as UV dosage, remains the same. The intensity and exposure time is governed by the geometry and the hydrodynamics of the UV unit. The UV unit is designed such that the lowest dose received by any of the water is sufficient to achieve the desired effect on microorganisms. The dosage is normally expressed in microwatt-seconds/sq cm. UV irradiation is effective against bacteria at dosage levels of 3 to 30 mJ/cm² and against viruses at 30 to 100 mJ/cm². In addition, recent studies have shown that UV radiation is also effective against Giardia and Cryptosporidium, causing internal damage and eliminating their threat, even when they are exposed to dosage levels in the tens of mJ/cm².

Referring to FIGS. 1A and 1B, an example of a typical, prior, commercial UV disinfection unit is illustrated. In this design, the straight UV bulb is located at the center of the pipe and the water flows through the annular space. The UV bulb radius is R_{B} (m), water pipe radius is R_{P} (m), and the length of the disinfector is L (m). The water volumetric flow rate is G (m³/s).

In this typical commercial UV treatment unit, water is flushed through a reactor vessel, where a UV lamp located in the center of the pipe irradiates the flowing water. In this unit, the distribution of the UV dose is extremely non-uniform so that at distances away from the UV light source, the UV dosage may be too low to kill microorganisms. As a result, in these prior commercial UV treatment units, more power and a very high power bulb at the center of the pipe are needed to meet the minimum dosage requirement at the pipe surface for effective treatment of the water. Some prior UV treatment units have added baffles to the reactor vessel to help generate radial mixing for a more uniform exposure of the water to UV, but they add to the cost and complexity of the unit.

### SUMMARY

A disinfection system in accordance with embodiments of the present invention includes a reactor with a chamber and at least one radiation source. The chamber in the reactor has at least one inlet that is oriented to generate a vortex motion for a fluid introduced to the chamber. The radiation source is positioned to be offset from an axis which extends along a center of the chamber of the reactor and to at least partially direct radiation towards a circulating flow of the fluid in the chamber from the vortex motion in a gap between a wall of the chamber of the reactor and the radiation source.

A method for making a disinfection system in accordance with other embodiments of the present invention includes forming an inlet to a chamber in a reactor in a manner that generates a vortex motion for fluid introduced into the chamber via the inlet. At least one radiation source is positioned to be offset from an axis which extends along a center of the chamber of the reactor and to at least partially direct radiation towards a circulating flow of the fluid in the chamber from the vortex motion in a gap between a wall of the chamber of the reactor and the at least one radiation source.

A method of disinfecting a fluid in accordance with other embodiments of the present invention includes introducing a fluid into a chamber in a reactor with an inlet which is oriented to generate a vortex motion for the introduced fluid. A circulating flow of the fluid in the chamber from the vortex motion is at least partially directed in a gap between a wall of the reactor and at least one radiation source which is positioned to be offset from an axis which extends along a center of the chamber of the reactor. The radiation at least partially disinfects the fluid which is then output.

The present invention provides an effective and energy efficient ultraviolet (UV) radiation disinfection system and method. With the present invention, the orientation of the inlet to the chamber in the reactor generates a vortex motion in the fluid is similar to what a baffle or similar structure might produce, but without the additional time and expense of installing these baffles. Further, the present invention is easily scalable and can be adapted to larger reactor or pipe applications with the use of multiple off-center UV light sources.

### BRIEF DESCRIPTION OF THE DRAWINGS

FIG. 1A is a perspective view of a prior UV disinfection unit;

FIG. 1B is an end view of the prior UV disinfection unit shown in FIG. 1A;

FIG. 2A is a cross-sectional view of a disinfection system in accordance with embodiments of the present invention;

FIG. 2B is an end view of the disinfection system shown in FIG. 2A;

FIG. 3A is a cross-sectional view of a disinfection system in accordance with other embodiments of the present invention;

FIG. 3B is an end view of the disinfection system shown in FIG. 3A;

FIG. 4A is a perspective view of a disinfection system in accordance with yet other embodiments of the present invention;

FIG. 4B is another perspective view of the disinfection system shown in FIG. 4A with the pipe or reactor shown in phantom; and

FIG. 5 is a graph of UV dosage versus UV input power of test results for commercial UV disinfection systems and the disinfection systems in accordance with embodiments of the present invention.

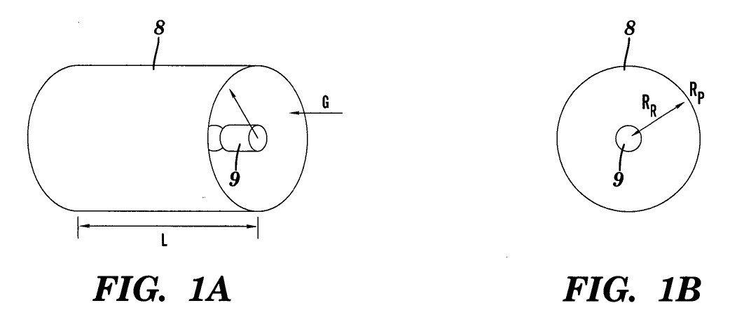

### DETAILED DESCRIPTION

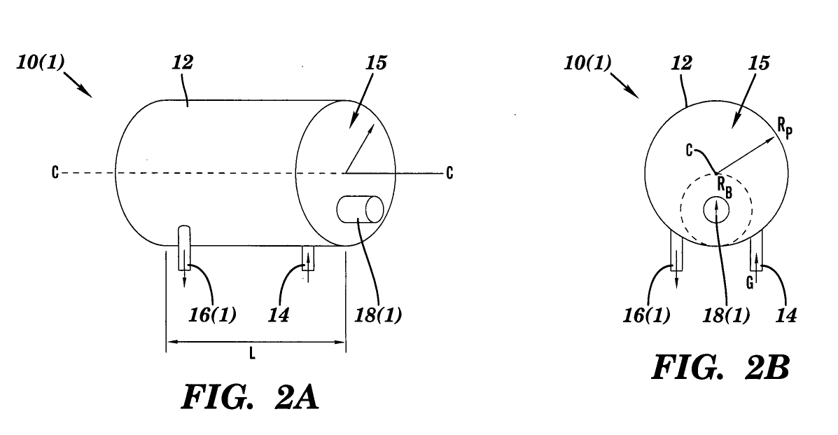

A disinfection system or reactor 10(1) in accordance with embodiments of the present invention is illustrated in FIGS. 2A and 2B. The disinfection system 10(1) includes a pipe 12 with an inlet 14 and an outlet 16(1) and a UV light source 18(1), although the disinfection system 10(1) can comprise other numbers and types of components in other configurations, such as with other types of radiation sources and housings. The present invention provides an effective and energy efficient ultraviolet (UV) radiation disinfection system and method.

Referring to FIGS. 2A and 2B, the elongated tube 12 defines an internal chamber 15 and with a circular cross-sectional shape, although the tube 12 can have other shapes and configurations and other types of conduits or reactors can be used. The inlet 14 to the chamber 15 in the pipe 12 is oriented to tangentially introduce a fluid into the chamber 15 to generate a strong vortex flow in the introduced fluid, although other numbers and types of inlets could be used in other configurations which generate a vortex flow for the fluid in the chamber 15. The vortex motion generated in the fluid is similar to what a baffle or similar structure in the chamber 15 of pipe 14 might produce, but without the additional time and expense of installing these baffles. The outlet 16(1) to the chamber 15 in the pipe 12 is also oriented to allow the fluid in the chamber 15 to exit tangentially, although the outlet 16(1) could have other orientations.

The UV light source 18(1) is positioned in the chamber 15 of the pipe 12 to be offset from an axis C-C extending through the center of the pipe 12, although other numbers and types of radiation sources and other orientations and locations for the UV light source can be used, such as outside of a chamber which is at least partially transmissive to UV light. In this embodiment, the UV light source 18(1) in the chamber 15 does not interfere with flow of the fluid within the chamber 15. When turned on, the UV light source 18(1) outputs the short wave portion of the UV spectrum, referred to as UV-C which spans from about 200 nm to about 280 nm, although the UV light source 18(1) can output radiation at other wavelengths and ranges to disinfect the fluid, such as between 100 nm and 400 nm by way of example only. The UV light source 18(1) is electrically coupled to a power source that provides power to operate the UV light source 18(1) when engaged in manners well known to those of ordinary skill in the art.

With the offset positioning of the UV light source 18(1) in the chamber 15, a stronger UV intensity field is established in the dashed-line circle as shown in FIG. 2B. Since the radius of the dashed-line circle is about half of the radius of the pipe 12, the UV intensity in the dashed-line circle is about 40% higher than that on the surface of the pipe 12, consequently increasing the dosage within the area in the dashed-line circle. The dosage in this dashed-line circle is also sufficient to substantially disinfect the fluid and, as illustrated, this circle is spaced in from a portion of an inner surface of the chamber 15 in the pipe 12. As a result, a lower power and less expensive UV light source 18(1) can be used because the intensity of the radiation does not need to extend across the entire chamber 15.

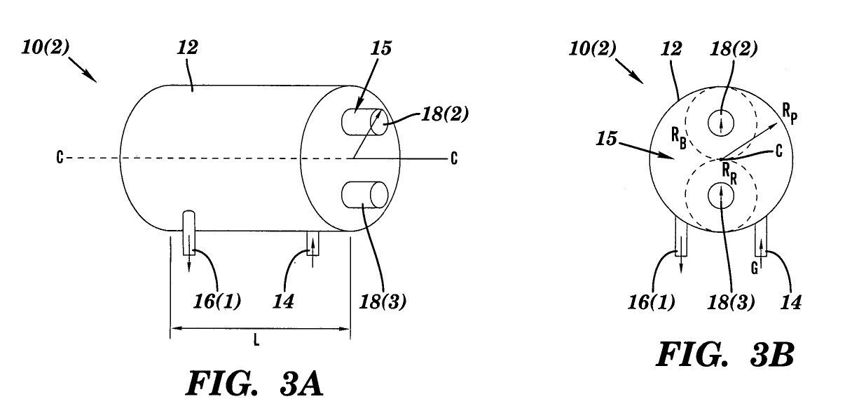

Referring to FIGS. 3A and 3B, a perspective view and end view of another disinfection system or reactor 10(2) in accordance with other embodiments of the present invention is illustrated. This embodiment for system 10(2) is identical to the embodiment for system 10(1) shown in FIGS. 2A and 2B, except as set forth herein.

The system 10(2) includes UV light sources 18(2) and 18(3) which are each positioned in the chamber 15 of the pipe 12 to be offset from an axis C-C extending through the center of the pipe 12, although other numbers and types of radiation sources and other orientations for the UV light source can be used. The UV light sources 18(2) and 18(3) do not interfere with flow of the fluid within the chamber 15. When turned on, the UV light sources 18(2) and 18(3) each output the short wave portion of the UV spectrum referred to as UV-C which spans from about 200 nm to about 280 nm, although the UV light sources 18(2) and 18(3) can output radiation at other wavelengths and ranges to disinfect the fluid, such as between 100 nm and 400 nm by way of example only. The UV light sources 18(2) and 18(3) are each electrically coupled to a power source that provides power to operate the UV light sources 18(2) and 18(3) when engaged in manners well known to those of ordinary skill in the art.

With the offset positioning of each of the UV light sources 18(2) and 18(3) in the chamber 15, a stronger UV intensity field is established in each of the dashed-line circles as shown in FIG. 3B. Since the radius of each of the dashed-line circles is about half of the radius of the pipe 12, the UV intensity at each of the dashed-line circles is about 40% higher than that on the surface of the pipe 12, consequently increasing the dosage within the area in each of the dashed-line circles. The dosage in these dashed-line circles is also sufficient to substantially disinfect the fluid and, as illustrated, these circles are spaced in from a portion of an inner surface of the chamber 15 in the pipe 12. As a result, lower power and less expensive UV light sources 18(2) and 18(3) can be used because the intensity of the radiation does not need to extend across the entire chamber 15. As this embodiment illustrates, the present invention is easily scalable and can be adapted to larger diameter pipes.

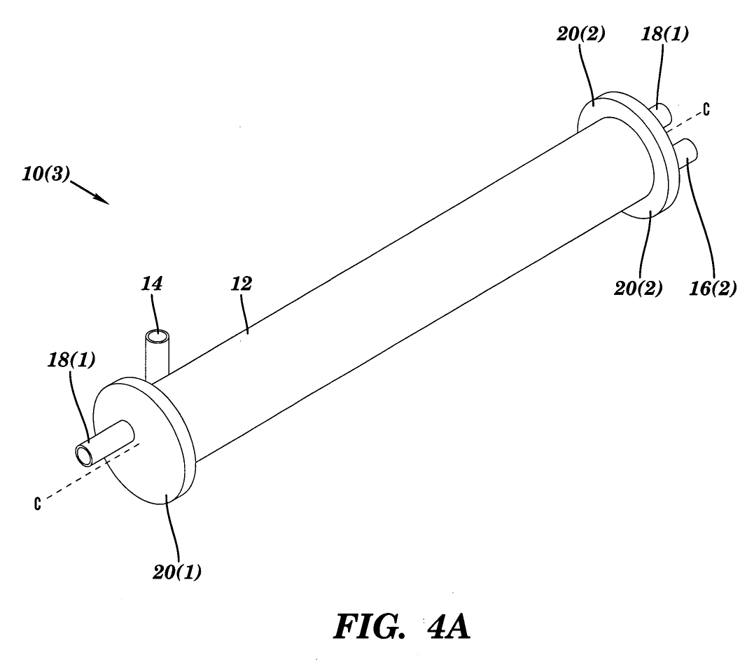

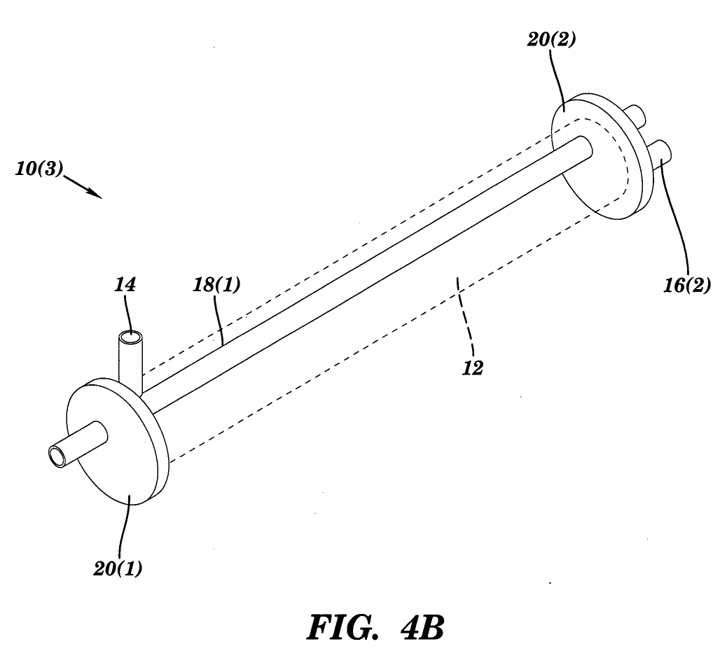

Referring to FIGS. 4A and 4B, another disinfection system or reactor 10(3) in accordance with other embodiments of the present invention is illustrated. This disinfection system 10(3) is the same in structure and operation as the disinfection system 10(1) shown in FIGS. 2A and 2B, except as described herein. For ease of illustration, the tube 12 and flanges 20(1) and 20(2) are shown in phantom in FIG. 4B.

In this embodiment, the outlet 16(2) to the chamber 15 in the pipe 12 is also oriented to allow the fluid in the chamber 15 to exit in an axial direction, although the outlet 16(2) could have other orientations. Additionally, flanges 20(1) and 20(2) are used to seal the opposite ends of the pipe 12 to form the chamber 15, although other numbers and types of flanges or other sealing devices could be used and pipe 12 could be constructed in other manners.

The operation of the disinfection system 10(1) will now be described with reference to FIGS. 2A and 2B. The disinfection system 10(1) is fluidly connected between ends of a pipe 12 carrying a fluid to be disinfected, such as water. To begin the disinfection process, a fluid is introduced into the inlet 14 to the chamber 15 in the pipe 12. The inlet 14 is oriented to tangentially introduce the fluid into the chamber 15 which generates a strong vortex flow in the introduced fluid.

Meanwhile, when the disinfection system 10(1) is engaged, power is supplied to the UV light source 18(1), which is offset from an axis C-C extending through the center of the pipe 12, to generate UV light between about 200 nm to about 280 nm. The UV light source 18(1) directs this UV light into the fluid in the dashed-line circle at a dosage which is sufficient to substantially disinfect the fluid, although radiation at other wavelengths could be introduced. With the vortex motion for the fluid resulting from the tangential orientation of the inlet 14, the flow of the introduced fluid is forced to circulate through the circle dashed-line area shown in FIG. 2B and expose it to the higher and uniform dosage of UV from the UV light source 18(1). This exposure substantially disinfects the fluid in the chamber 15. Once the fluid has passed the UV light source 18(1), the disinfected fluid is output from the chamber 15 via the outlet 16(1) into the end of the other pipe of the system in which the disinfection system 10(1) was installed, although the disinfected fluid can be output in other manners, such as for directly for use.

The outlet 16(1) is oriented to direct the fluid out of the chamber 15 in a tangential direction with respect to the pipe 12. This tangential orientation for the outlet 16(1) is simpler to manufacture and allows the outlet 16(1) to be spaced further from the bulb 18(1).

The operation of the disinfection system 10(2) shown in FIGS. 3A and 3B is the same as the operation for the disinfection system 10(1) shown in FIGS. 2A and 2B, except as set forth herein. In this embodiment, when the disinfection system 10(2) is engaged, power is supplied to the UV light sources 18(2) and 18(3), which are each offset from an axis C-C extending through the center of the pipe 12, to each generate UV light between about 200 nm to about 280 nm. The UV light sources 18(2) and 18(3) each direct this UV light into the fluid in the dashed-line circles at a dosage which is sufficient to substantially disinfect the fluid, although radiation at other wavelengths could be introduced. With the vortex motion for the fluid resulting from the tangential orientation of the inlet 14, the flow of the introduced fluid is forced to circulate through each of the circle dashed-line areas shown in FIG. 3B and expose it to the higher and uniform dosage of UV from the UV light sources 18(2) and 18(3). This exposure substantially disinfects the fluid in the chamber 15. Once the fluid has passed the UV light sources 18(2) and 18(3), the disinfected fluid is output from the chamber 15 via the outlet 16(1) into the end of the other pipe of the system in which the disinfection system 10(2) was installed, although the disinfected fluid can be output in other manners, such as for directly for use. The outlet 16(1) is oriented to direct the fluid out of the chamber 15 in a tangential direction with respect to the pipe 12.

The operation of the disinfection system 10(3) shown in FIGS. 4A and 4B is the same as the operation for the disinfection system 10(1) shown in FIGS. 2A and 2B, except as set forth herein. In this embodiment, once the fluid has passed the UV light source 18(1), the disinfected fluid is output from the chamber 15 via the outlet 16(2) axially into the end of the other pipe of the system in which the disinfection system 10(3) was installed, although the disinfected fluid can be output in other manners, such as for directly for use. The axially directed outlet 16(2) provides more a persistent vortex (helical) motion up until the end of the disinfection system 10(3).

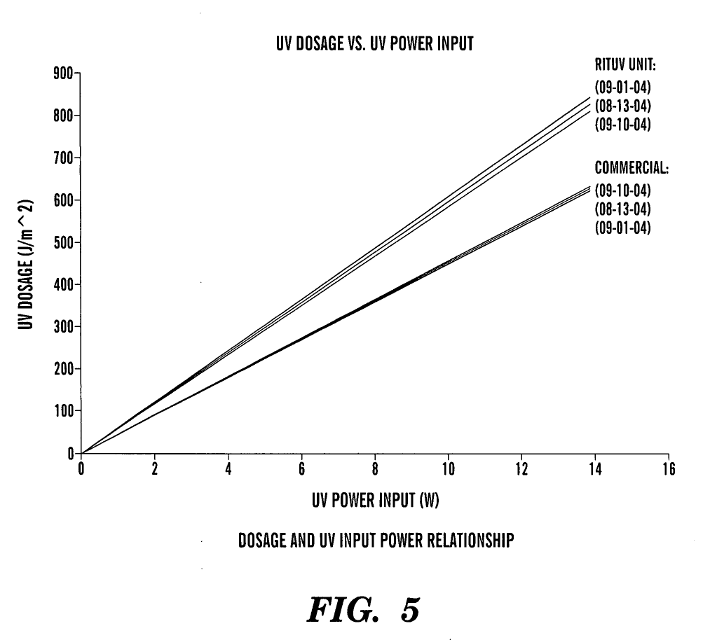

By way of example only, a graph of test results of UV dosage versus UV input power for prior commercial UV disinfection unit and RITUV disinfection systems in accordance with embodiments of the present invention is illustrated in FIG. 5. As the graph illustrates, the RITUV disinfection systems in accordance with the present invention consume less energy than the commercial units for generating the same UV dosage. More specifically, the present invention can provide around 33% higher dosage values at the rated (13.8 W) power input than the prior commercial unit. In these examples, this can point to potential energy savings with the present invention.

Accordingly, as described above the present invention provides an effective and energy efficient ultraviolet (UV) radiation disinfection system and method. With the present invention, as water or other fluids flow through one of the UV disinfection systems 10(1)-10(3) the vortex motion and the radiation from the offset UV light source or sources will kill contaminants, such as bacteria, viruses and protozoa, to substantially disinfect the fluid. The present invention can be used in a number of applications, including as a drinking-water and wastewater disinfection system, and can be used at a variety of locations, such as at home, a water plant or other kinds of water supply facilities.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are-intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A disinfection system comprising:
a reactor with a chamber and at least one inlet to the chamber, the inlet is oriented to generate a vortex motion for a fluid introduced into the chamber; and
at least one radiation source which is positioned to be offset from an axis which extends along a center of the chamber of the reactor and to at least partially direct radiation towards a circulating flow of the fluid in the chamber from the vortex motion in at least a gap between a wall of the chamber of the reactor and the at least one radiation source.

2. The system as set forth in claim 1 wherein the inlet is oriented to tangentially direct a flow of the fluid into the chamber.

3. The system as set forth in claim 1 wherein the radiation source is located in the chamber of the reactor at the off-set location from the axis which extends along the center.

4. The system as set forth in claim 2 further comprising an outlet to the chamber in the reactor that is oriented to direct the flow of the fluid out of the chamber in a substantially tangential direction with respect to the axis.

5. The system as set forth in claim 2 further comprising an outlet to the chamber in the reactor that is oriented to direct the flow of the fluid out of the chamber in a substantially axially direction with respect to the axis.

6. The system as set forth in claim 1 wherein an outer perimeter location of the radiation from the radiation source which is at a dosage sufficient to substantially disinfect the fluid is spaced in from at least a portion of an inner surface of the chamber in the reactor.

7. The system as set forth in claim 1 wherein the radiation source is an ultraviolet light source.

8. The system as set forth in claim 1 wherein the at least one radiation source comprises a plurality of radiation sources, each of the radiation sources is at a different location which is offset from the axis which extends along the center of the chamber of the reactor.

9. The system as set forth in claim 8 wherein each of the plurality of radiation sources are elongated and positioned to extend along in at least a general direction of the axis which extends along the center of the chamber of the reactor.

10. A method for making a disinfection system, the method comprising:
forming an inlet to a chamber in a reactor in a manner that generates a vortex motion for fluid introduced into the chamber via the inlet; and
positioning at least one radiation source to be offset from an axis which extends along a center of the chamber of the reactor and to at least partially direct radiation towards a circulating flow of the fluid in the chamber from the vortex motion in at least a gap between a wall of the chamber of the reactor and the at least one radiation source.

11. The method as set forth in claim 10 wherein the forming the inlet further comprises forming the inlet to be oriented to tangentially direct a flow of the fluid into the chamber.

12. The method as set forth in claim 10 wherein the positioning at least one radiation source further comprises positioning the radiation source in the chamber of the reactor at the off-set location from the axis which extends along the center.

13. The method as set forth in claim 11 further comprising forming an outlet to the chamber in the reactor in that will direct a flow of the fluid out of the chamber in a substantially tangential direction with respect to the axis.

14. The method as set forth in claim 11 further comprising forming an outlet to the chamber in the reactor in that will direct the flow of the fluid out of the chamber in a substantially axially direction with respect to the axis.

15. The method as set forth in claim 10 wherein the positioning at least one radiation source further comprises positioning the radiation source so an outer perimeter location of the radiation from the radiation source which is at a dosage sufficient to substantially disinfect the fluid is spaced in from at least a portion of an inner surface of the chamber in the reactor.

16. The method as set forth in claim 10 wherein the radiation source is an ultraviolet light source.

17. The method as set forth in claim 10 wherein the positioning at least one radiation source further comprises positioning each of a plurality of radiation sources at a different location which is offset from the axis which extends along the center of the chamber of the reactor.

18. The method as set forth in claim 17 wherein the positioning each of a plurality of radiation sources further comprises positioning each of the plurality of radiation sources which are elongated to extend along in at least a general direction of the axis which extends along the center of the chamber of the reactor.

19. A method of disinfecting a fluid, the method comprising:
introducing a fluid into a chamber in a reactor with an inlet which is oriented to generate a vortex motion for the introduced fluid; and
at least partially directing a circulating flow of the fluid in the chamber from the vortex motion in at least a gap between a wall of the chamber of the reactor and at least one radiation source which is positioned to be offset from an axis which extends along a center of the chamber of the reactor, the radiation at least partially disinfecting the fluid; and
outputting the at least partially disinfected fluid.

20. The method as set forth in claim 19 wherein the inlet is oriented to tangentially direct a flow of the fluid into the chamber.

21. The method as set forth in claim 19 wherein the radiation source is located in the chamber of the reactor at the off-set location from the axis which extends along the center.

22. The method as set forth in claim 20 wherein the outputting the at least partially disinfected fluid further comprises outputting the at least partially disinfected fluid with an outlet oriented to direct the flow of the fluid out of the chamber in a substantially tangential direction with respect to the axis.

23. The method as set forth in claim 20 wherein the outputting the at least partially disinfected fluid further comprises outputting the at least partially disinfected fluid with an outlet oriented to direct the flow of the fluid out of the chamber in a substantially axially direction with respect to the axis.

24. The method as set forth in claim 19 wherein an outer perimeter location of the radiation from the radiation source which is at a dosage sufficient to substantially disinfect the fluid is spaced in from at least a portion of an inner surface of the chamber in the reactor.

25. The method as set forth in claim 19 wherein the radiation source is an ultraviolet light source.

26. The method as set forth in claim 19 wherein the at least partially directing radiation towards the fluid in the chamber with at least one radiation source further comprises at least partially directing radiation from each of a plurality of different radiation sources that are each at a different location which is offset from the axis which extends along the center of the chamber of the reactor.

27. The method as set forth in claim 26 wherein each of the plurality of radiation sources are elongated and positioned to extend along in at least a general direction of the axis which extends along the center of the chamber of the reactor.
